(19) United States
(12) Patent Application Publication
(10) Pub. No.: US 2009/0259625 A1
(43) Pub. Date: Oct. 15, 2009

(54) METHODS INVOLVING TAGGING

(75) Inventor: Katsuhisa Kataoka, Kanagawa-ken (JP)

Correspondence Address: Cantor Colburn LLP-IBM Europe, 20 Church Street, 22nd Floor, Hartford, CT, 06103, US

(73) Assignee: INTERNATIONAL BUSINESS MACHINES CORPORATION, Armonk, NY (US)

(21) Appl. No.: 12/102,073

(22) Filed: Apr. 14, 2008

(51) Int. Cl. G06F 17/30

(52) U.S. Cl. 707/3; 707/E17.123

(57) ABSTRACT

A method for tagging data content, the method comprising, receiving a tag associated with a data content having a data content identifier from a first user, associating the tag with a tag identifier, associating the tag with a user identifier of the first user, saving the tag identifier, the data content identifier, the tag, and a privacy designation associated with the tag identifier in a first table responsive to determining that the tag associated with the data content identifier is not present in the first table, and saving the user identifier and the tag identifier in a second table responsive to determining that the user identifier and the tag identifier are not present in the second table.

### BACKGROUND OF THE INVENTION

1. Field of the Invention

This invention relates generally to metadata in information systems, and more particularly, to methods involving tagging data in information systems.

2. Description of Background

Information systems such as the Internet and intranet systems contain large amounts of data content, such as, for example, memoranda, spreadsheets, letters, photos, articles, and message board content. The data content stored in these systems is more useful if users may access it efficiently. Metadata is data used to describe data content.

Metadata includes tags that are words or phrases relating to the data content. Systems may include a file with the data content and a file with tags associated with the data content. Usually an author or user of data content adds tags associated with the data content to aid other users in accessing the data. For example, an article on electrical power generation may have associated tags such as, hydroelectric power, turbines, power grid, and generators. When a user initiates a search having any of the associated tags, the article will be included as a search result.

In many data systems, users who have accessed the data content may add tags associated with the data content. Allowing multiple users to add tags makes metadata more useful. For example, if the article on electrical power generation also includes information about electrical power generation in Japan, a user who has read the article may add a tag such as “electrical power generation in Japan.” The new tag may aid another user who searches for articles about electrical power generation in Japan. The metadata associated with the article will improve as more users add tags.

In many data systems, particularly business and academic systems, the tagged data content is accessed by a small group of users. Appropriate tags may not be added to the metadata if a user is hesitant to add tags that may be misinterpreted, or if a user is not confident that the tag they are adding is appropriate. For example, an academic paper may include conclusions that are incorrect. Users who access the paper may hesitate to add tags that reflect negatively on the paper. The reluctance of users to add tags that may reflect negatively on the user who adds the tags results in a loss in the effectiveness of the tags.

It is desirable to provide a method for tagging data content that encourages users to add appropriate tags to the data content.

### SUMMARY OF THE INVENTION

The shortcomings of the prior art are overcome and additional advantages are achieved through an exemplary method for tagging data content, the method comprising, receiving a tag associated with a data content having a data content identifier from a first user, associating the tag with a tag identifier, associating the tag with a user identifier of the first user, saving the tag identifier, the data content identifier, the tag, and a privacy designation associated with the tag identifier in a first table responsive to determining that the tag associated with the data content identifier is not present in the first table, and saving the user identifier and the tag identifier in a second table responsive to determining that the user identifier and the tag identifier are not present in the second table.

An exemplary method for displaying a tag associated with data content comprising, determining whether a number of user identifiers associated with a tag equals a threshold value, designating the tag as private responsive to determining that the number of user identifiers associated with the tag is less than the threshold value, restricting access to the tag to a first user set responsive to designating the tag as private, designating the tag as public responsive to determining that the number of tag identifiers associated with the tag exceeds the threshold value, and authorizing access to the tag to a second user set responsive to designating the tag as public.

An alternate exemplary method for tagging data content, the method comprising, receiving a tag hint request associated with a first data content file from a second user in a second user set, retrieving tags associated with a plurality of data content files, defining the retrieved tags as proposed tags, displaying the proposed tags, wherein the proposed tags include private tags accessible to a first user set, receiving an indication of a proposed tag selected by the second user, associating the selected proposed tag with a data content identifier of the first data content file, saving the selected proposed tag and the data content identifier in a first table.

Additional features and advantages are realized through the techniques of the present, invention. Other embodiments and aspects of the invention are described in detail herein and are considered a part of the claimed invention. For a better understanding of the invention with advantages and features, refer to the description and to the drawings.

### BRIEF DESCRIPTION OF THE DRAWINGS

The subject matter that is regarded as the invention is particularly pointed out and distinctly claimed in the claims at the conclusion of the specification. The foregoing and other aspects, features, and advantages of the invention are apparent from the following detailed description taken in conjunction with the accompanying drawings in which:

FIG. 1 illustrates and exemplary embodiment of an information system.

FIG. 2 illustrates an exemplary embodiment of the data content table of FIG. 1.

FIG. 3 illustrates exemplary embodiments of the tag-data correspondence table and user-tag correspondence table of FIG. 1.

FIG. 4 illustrates a block diagram of an exemplary method for designating tags.

FIG. 5 illustrates an exemplary embodiment of a display window.

FIG. 6 illustrates a block diagram of an exemplary method for providing tag hints.

The detailed description explains the preferred embodiments of the invention, together with advantages and features, by way of example with reference to the drawings.

### DETAILED DESCRIPTION OF THEE INVENTION

Systems and methods involving tagging data content are provided.

In this regard, tags may be added to a tag file associated with data content to aid in searching for the data content. The tag file is available to a variety of users who access the data content. In some applications, appropriate tags for a data content file may, for example, reflect negatively (in a social context) on the data content or the user who has added the tags. Some users are reluctant to add appropriate tags to a tag file that may result in negative social implications. It is desirable for a tagging method and system that encourages users to add appropriate tags for data content even if the tags may result in a negative social reflection on a user. The method and system described below encourages users to enter appropriate tags in a tag file that is associated with data content.

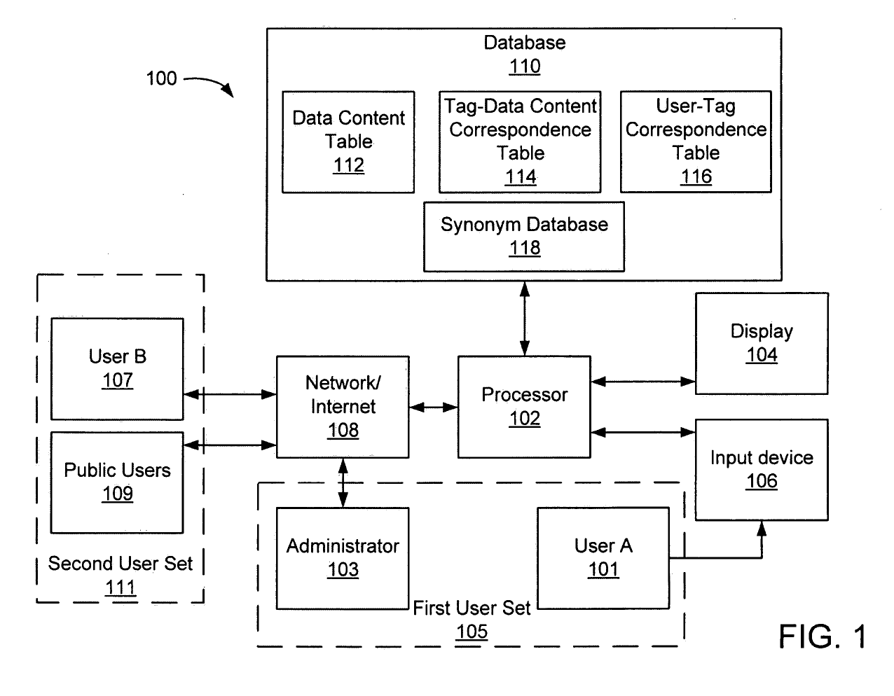

FIG. 1a illustrates an exemplary embodiment of a data system 100. The data system 100 includes a processor 102 communicatively connected to a display 104, an input device 106, and a network 108 that may include the Internet. The processor 102 is also communicatively connected to a database 110 having a data content table 112, a tag-data content correspondence table 114, and a user-tag correspondence table 116. A first user set 105 includes a User A 101, and may include other users, such as, for example, an administrator/moderator 103. A second user set 111 includes a User B 107, and may include other users such as, for example, public users 109.

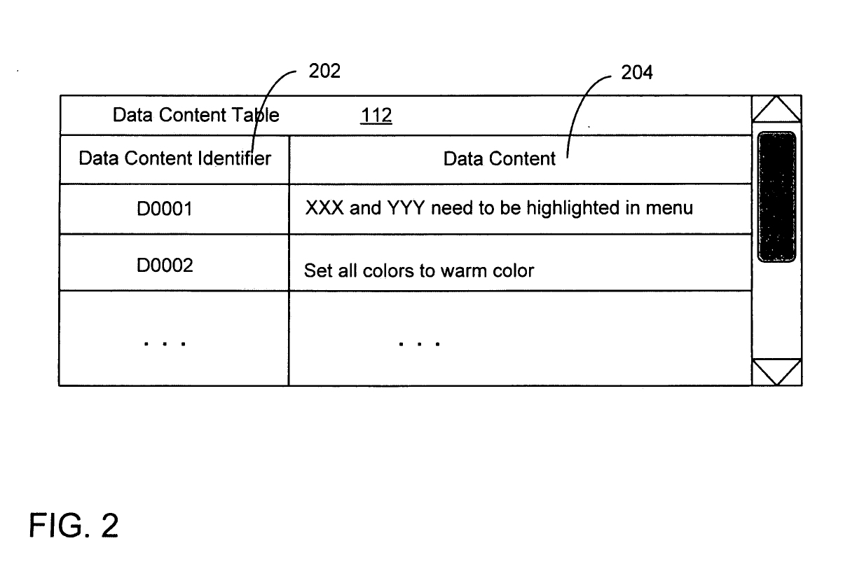

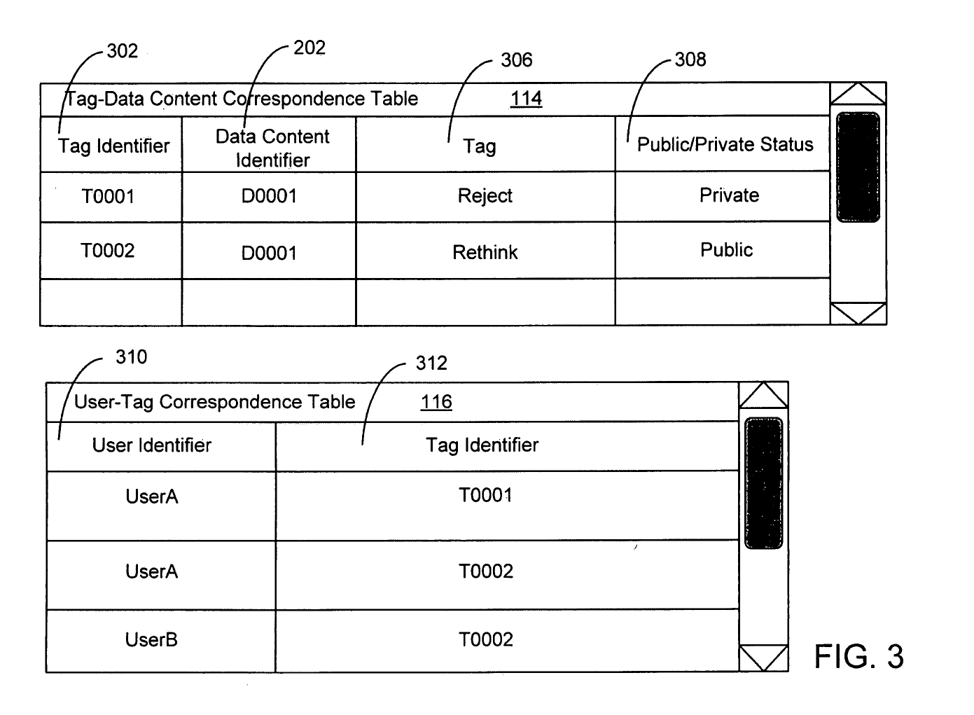

FIGS. 2 and 3 illustrate exemplary embodiments of the data content table 112, the tag-data content correspondence table 114, and the user-tag correspondence table 116. The data content table includes data content 204 and data continent identifiers 202. When data content is saved in the database 110, the data content 204, or a portion of the data content 204 is saved in the data content table 112. A data content identifier 202 is associated with the data content 204 and saved in the data content table 112.

FIG. 3 illustrates an exemplary embodiment of the tag-data content correspondence table 114 including tag identifiers 302, data content identifiers 202, tags 306, and privacy designators 308. An exemplary method of operation is described below.

To tag data content, a user such as, for example, User A 101 (of FIG. 1) sends a tag 306 associated with data content 204 and a data content identifier 202 of the data content 204 to the processor 102. The processor 102 receives the data content identifier 202 and the tag 306. The processor 102 associates a tag identifier 302 with the tag 306. The tag identifier 302, the data content identifier 202, and the tag 306 are saved in the tag-data content correspondence table 114.

FIG. 3 also includes an exemplary embodiment of the user-tag correspondence table 116 including a user identifiers 310 and tag identifiers 302. After the processor 102 saves the tag identifier 302, the data content identifier 202, and the tag 306, the user identifier 310 associated with the User A 101 is saved in the user-tag correspondence table 116. The tag identifier 302 is also saved in the user-tag correspondence table 116.

The processor 102 then counts a number of user identifiers 310 that have the same tag identifier 302 and determines whether the count is less than a defined threshold value. If the count is less than the defined threshold value, the tag 306 is designated with a privacy designation 308 of private. If the count is equal to or greater than the defined threshold value, the tag 306 is designated with a privacy designation 308 of public.

For example, FIG. 2 includes two data content files 204 having data content identifiers 202. When User A 101 (of FIG. 1) sends a tag 306 of “Reject” for the data content 204 having the data content identifier 202 “D0001,” the processor 102 associates the tag 306 with a tag identifier 302 of “T0001.” The processor then saves the tag identifier 302, the data content identifier 202, and the tag 306 in the tag-data content correspondence table 114. The processor 102 also saves the user identifier 310 “User A” and the tag identifier 302 in the user-tag correspondence table 116. The processor 102 counts the number of user identifiers 310 associated with the tag identifier 302 “T0001.” The processor 102 determines whether the count is equal to or greater than the defined threshold value. In the illustrated example, the threshold value is 2. Since there is only one user identifier 310 associated with the tag identifier 302 “T0001,” the processor 102 designates the tag 306 “Reject” with a privacy designation 308 of “Private.”

FIG. 3 also includes a previously entered tag 306 “Rethink” having a tag identifier 302 “T0002” in the tag-data content correspondence table 114. The user-tag correspondence table 116 includes two user identifiers 310, “User A” and “User B” that have been associated with the tag identifier 302 “T0002.” Since the defined threshold value is 2, and the number of user identifiers 310 associated with the tag identifier 302 “T0002” equals the threshold value, the processor 102 has set the privacy designation 308 of the tag 306 “Rethink” to “Public.”

The privacy designation 308 may be used to restrict access to tags 306 and the associated data content identifier 202. For example, a tag 306 with a “Private” privacy designation 308 may only be available to the user having the user identifier that entered the tag 306, while a tag with a “Public” privacy designation 308 may be available to a greater number of users, or the general public.

By changing the privacy designation 308 to “Public” once a defined number of users have entered the same tag 306, the tag 306 will become available to other users. Thus, a user may enter a tag 306 with confidence that the tag will not be available to other users until a number of additional users have added the same tag 306. The collaborative approach to adding tags 306 encourages users to add tags 306 that may have a negative social connotation because a user knows that a tag 306 will only become public if additional users “agree” that the tag 306 is appropriate. This method promotes users to enter tags 306 regardless of social connotations that may be associated with the tag 306.

User sets may be defined to allow access to public and private tags. For example, referring to FIG. 1, the first user set 105 may include the User A 101 that entered the tag 306, and an administrator/moderator 103. The User A 101 and the administrator/moderator 103 may only access a tag 306 that is entered by the User A 101 and designated private. Once the tag 306 has been designated public, the second user set 111 that may include, for example, the User B 107 and other “public” users 109 may access the tag 306. The user sets 105 and 111 may be changed to accommodate different work group preferences.

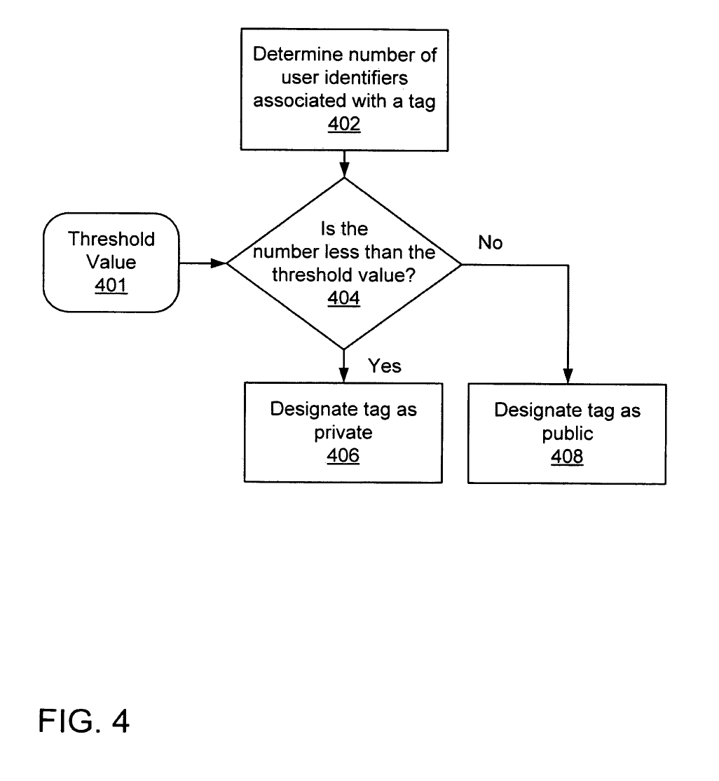

FIG. 4 illustrates a block diagram of an exemplary method for designating tags public and private. In block 402, the number of user identifiers associated with a tag is determined. If the number is determined to be less than a threshold value 401 in block 404, the tag is designated as private 406. If the number is determined to be equal to or greater than the threshold value 401, the tag is designated as public in block 408.

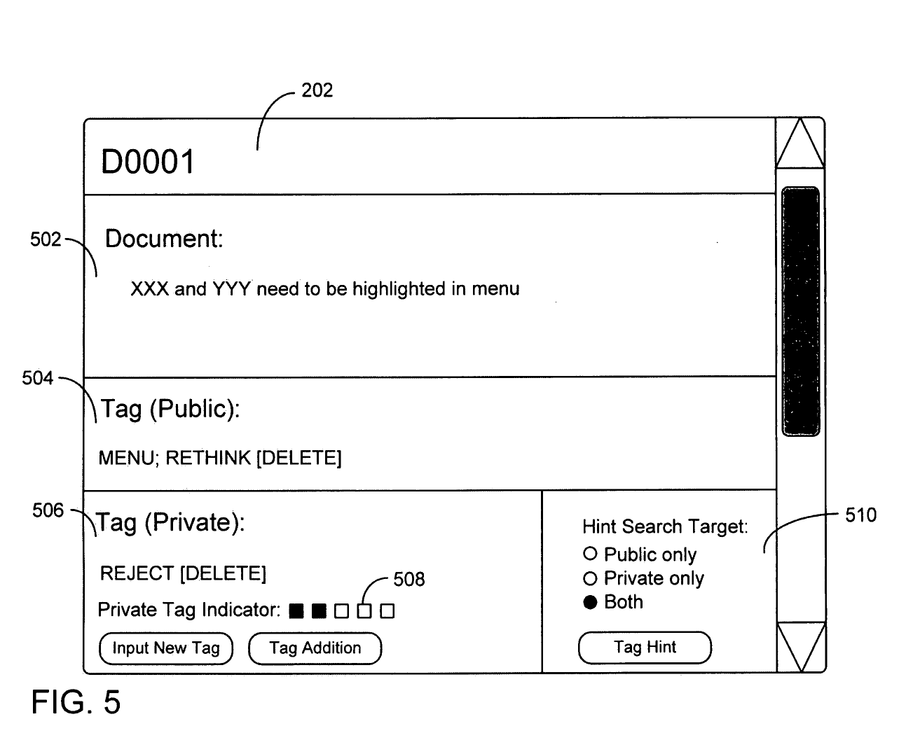

FIG. 5 illustrates an exemplary embodiment of a window having the data content identifier 202, of a data content document 502. A public tag box 504 includes public tags “menu” and “rethink” associated with the data content document 502. A private tag box 506 includes a private tag “reject.” In the illustrated example, a user has requested to view the tags 306 associated with the data content having the data content identifier 202 “D0001.” The user viewing the window is authorized to view the private tag “reject,” and may use the window to edit the tags 306, or add tags 306 associated with the data content-document 502.

A private tag indicator 508 is shown that indicates an amount of private tags associated with the data content document 502 that have been entered into the Tag-data content correspondence table 114 (of FIG. 3). The indicator allows a user to determine an amount of private tags that are associated with the data content document 502. If the indicator is high, a user may determine from the indicator that adding a new tag 306 will more likely result in a public tag designation for an added tag 306.

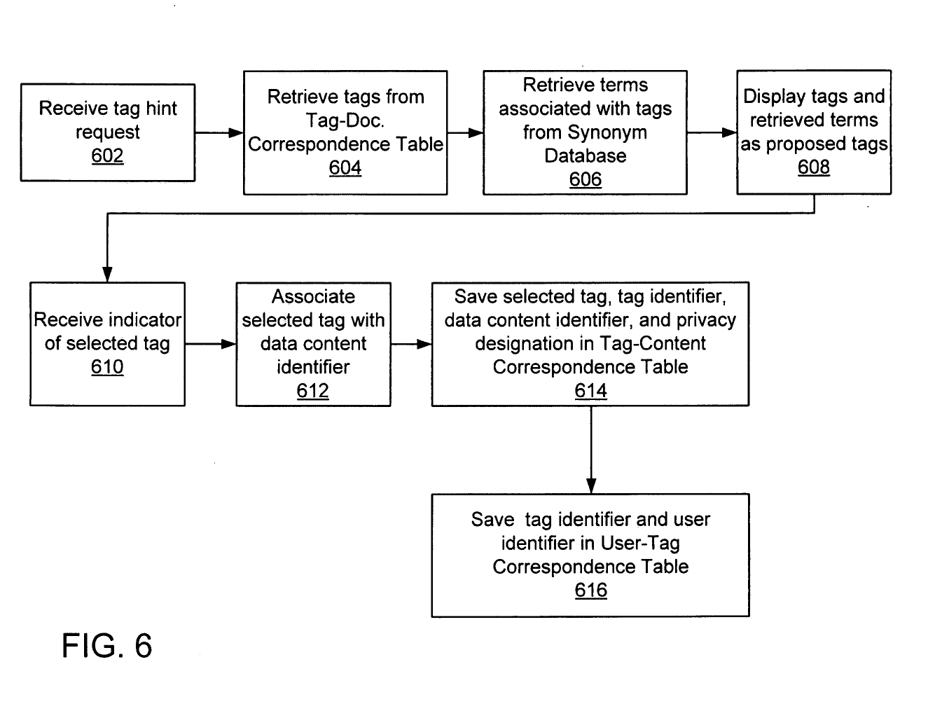

A hint search target box 510 is also shown in FIG. 5. By selecting a public only, private only, or both, a user may request a hint for adding additional tags to the tag-data content correspondence table 114. The hint may include a list of proposed tags that a user may select to associate with the data content document 502. The proposed tags may aid a user in tagging the data content document 502, and promote the use of common tags 306. FIG. 6 illustrates a block diagram of a method for saving tags using a tag hint.

Referring to FIG. 6, a tag hint request is received in block 602. Once the tag hint request is received, tags 306 are retrieved from the tag-data content correspondence table 114. The retrieved tags may include all of the public tags, all of the private tags, or a combination of both all of the private tags and all of the public tags that are saved in the tag-data content correspondence table 114. None of the retrieved tags include associations with any of the data content 204 or data content identifiers 202. Thus, even the private tags may be shown, without revealing the data content 204 associated with the private tags. This allows the anonymity of the private tags to be preserved. In block 606 the retrieved tags are associated with similar terms stored in the synonym database 118 (of FIG. 1). The synonym data base 118 is similar to a thesaurus and may allow additional tags to be proposed. In block 608 the retrieved tags and the similar terms from the synonym database 118 associated with the retrieved tags are displayed as proposed tags. The user may select and indicate a proposed tag to be added to the tag-data content correspondence table 114. In block 610 an indicator is received of the selected proposed tag. In block 612 the selected proposed tag is associated with the data content identifier 202 of the data content 204. The selected proposed tag, a tag identifier 302, the data content identifier 202 are saved in the data-content correspondence table 114 in block 614. A privacy designation may also be added in a similar manner as described above. In block 616, the tag identifier and user identifier of the user are saved in the user-tag correspondence table 116.

The technical effects and benefits of the above described methods encourages users to add tags that may have negative social connotations. The methods promote the addition of appropriate metadata to data content files to increase the efficiency and ease of accessing data in a data system.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for tagging data content, the method comprising:
receiving a tag associated with a data content having a data content identifier from a first user;
associating the tag with a tag identifier;
associating the tag with a user identifier of the first user;
saving the tag identifier, the data content identifier, the tag, and a privacy designation associated with the tag identifier in a first table responsive to determining that the tag associated with the data content identifier is not present in the first table; and
saving the user identifier and the tag identifier in a second table responsive to determining that the user identifier and the tag identifier are not present in the second table.

2. The method of claim 1, wherein the privacy designation is restricts access to the tag to a first user set.

3. The method of claim 2, wherein the first user set includes the first user.

4. The method of claim 1, wherein the privacy designation authorizes a second user set to access the tag.

5. A method for displaying a tag associated with data content comprising:
determining whether a number of user identifiers associated with a tag equals a threshold value;
designating the tag as private responsive to determining that the number of user identifiers associated with the tag is less than the threshold value;
restricting access to the tag to a first user set responsive to designating the tag as private;
designating the tag as public responsive to determining that the number of tag identifiers associated with the tag exceeds the threshold value; and
authorizing access to the tag to a second user set responsive to designating the tag as public.

6. The method of claim 3, wherein the first user set only includes users having user identifiers associated with the tag.

7. The method of claim 3, wherein the method further comprises:
receiving a data content request from a first user;
displaying the requested data content and public tag associated with the document;
determining a number of private tags associated with the data content; and
displaying a visual indicator corresponding to the number of private tags associated with the data content.

8. The method of claim 5, wherein the method further comprises:
receiving a request from the first user for a private tag associated with the data content;
determining whether a user identifier of the first user is associated with the private tag; and
displaying the private tag associated with the user identifier of the first user to the first user responsive to determining that the user identifier of the first user is associated with the private tag.

9. A method for tagging data content, the method comprising:
receiving a tag hint request associated with a first data content file from a second user in a second user set;
retrieving tags associated with a plurality of data content files;
defining the retrieved tags as proposed tags;
displaying the proposed tags, wherein the proposed tags include private tags accessible to a first user set;
receiving an indication of a proposed tag selected by the second user;
associating the selected proposed tag with a data content identifier of the first data content file;
saving the selected proposed tag and the data content identifier in a first table.

10. The method of claim 9, wherein the method further comprises retrieving terms associated with the tags in a synonym database responsive to retrieving the tags, wherein the proposed tags further include the retrieved terms.

11. The method of claim 9, wherein the method further comprises:
associating the tag with a tag identifier;
associating the tag with a user identifier of the second user;
saving the tag identifier and a privacy designation associated with the tag identifier in the first table; and
saving the user identifier and the tag identifier in a second table responsive to determining that the user identifier and the tag identifier are not present in the second table.

12. The method of claim 11, wherein the privacy designation is restricts access to the tag to a first user set.

13. The method of claim 12, wherein the first user set includes the second user.

14. The method of claim 11, wherein the privacy designation authorizes the second user set to access the tag.
